(19) United States
(12) Patent Application Publication
(10) Pub. No.: US 2016/0042585 A1
(43) Pub. Date: Feb. 11, 2016

(54) Game Apparatus, System and Method Employing Player-Influenced Odds

(71) Applicant: GTECH Corporation, Providence, RI (US)

(72) Inventors: Aaron Michael Koll, Lincoln, CA (US); Sarah W. Simpkins, Warwick, RI (US)

(21) Appl. No.: 14/451,875

(22) Filed: Aug. 5, 2014

(51) Int. Cl. G07F 17/32

(52) U.S. Cl. CPC G07F 17/329; G07F 17/3244

(57) ABSTRACT

A system, method and apparatus for providing a game allows the player greater control in selecting options that affect odds and payouts. In embodiments, the system, method and apparatus permit a player to select the number of free spaces on a game board.

### FIELD OF THE INVENTION

The present invention pertains to games, and more particularly to a game apparatus, system and method employing player-influenced odds of winning.

### BACKGROUND AND SUMMARY OF THE INVENTION

Bingo is a known game of chance. In many instances, Bingo is played by providing players with a substrate such as a playing card having player indicia pre-arranged in a table or grid/matrix, with column headers indicating a letter such as “B”, “I”, “N”, “G” and “O” and rows of numbers underneath each header. A game operator then randomly draws elements, such as ping pong balls, for example, with game indicia such as numbers or letter-number combinations printed on the elements. Alternatively, the game operator may run a software program for randomly selecting the game indicia. For example, one selected/determined game indicia may be “B1”, another may be “B2” another may be “O64”, etc. As the game indicia are randomly drawn and/or determined, players somehow mark their playing card to note that the number or letter/number combination has been called. A player can win the game by being the first to mark off a pre-determined pattern of game indicia (for example, a straight vertical line through a column of game indicia, a straight horizontal line through a row of game indicia, or a diagonal line through the matrix or a section of the matrix). In some Bingo games, players can win without being the first to complete a pre-defined pattern. Wins are typically validated for accuracy by checking that the player's card has the requisite pattern marked off before officially confirming the win and issuing prizes. In computerized versions, a win can be validated using a security code or other identifier provided on a physical card, ticket or receipt, or associated with a virtual card or ticket. Other games such as keno operate in similar ways to that described above.

In traditional Bingo, Keno and other similar games, the player indicia on the playing cards are provided as a subset of all of the available game indicia that can be determined. For instance, the game indicia may include a set of “B” game indicia from one to fifteen (i.e., B1 . . . B15), a set of “I” game indicia from sixteen to thirty (i.e., I16 . . . I30), and so forth up to O75. Nevertheless, each playing card may only have a limited number of playing indicia within each letter column (i.e., five “B” numbers from the group of B1 . . . B15, five “I” numbers, five “N” numbers, five “G” numbers and five “O” numbers). In this way, each card effectively has the same odds of winning, since the same number of matches is needed to mark off the player indicia in the prescribed pattern on each card. Further, in many instances of Bingo and related games, player card matrices may be provided with one or more “free” spaces, which essentially act as a marked spot to help each player come closer to marking off a pre-determined pattern of numbers. In such instances, the free spot can be positioned anywhere on the matrix, but is usually positioned in the middle of the matrix, such as where the third “N” number would otherwise be placed.

Many gaming establishments that offer Bingo, Keno and related games have a display board that shows the called game indicia, or that shows all of the available game indicia with the previously called game indicia somehow marked or illuminated.

Aspects of the present invention provide a game apparatus, system and method employing free spaces in such a way as to encourage player excitement and participation, thereby increasing the number and amount of wagers placed.

### BRIEF DESCRIPTION OF THE DRAWINGS

FIG. 1 is a schematic illustration of embodiments of the present invention.

FIG. 2 shows an exemplary player betslip for use in connection with embodiments of the present invention.

FIG. 3 shows exemplary prize structures for use in connection with embodiments of the present invention.

FIGS. 4 through 6 show exemplary game displays for use in connection with embodiments of the present invention.

FIGS. 7 and 8 show exemplary player tickets or receipts for use in connection with embodiments of the present invention.

### DETAILED DESCRIPTION OF EMBODIMENTS

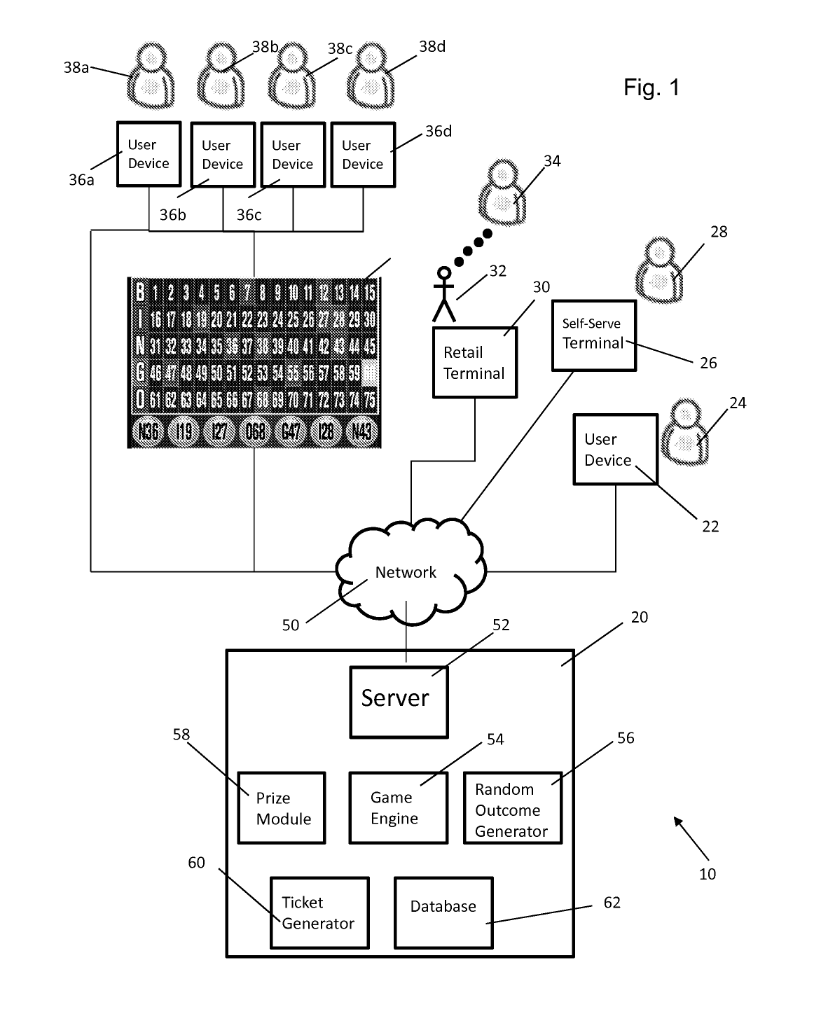

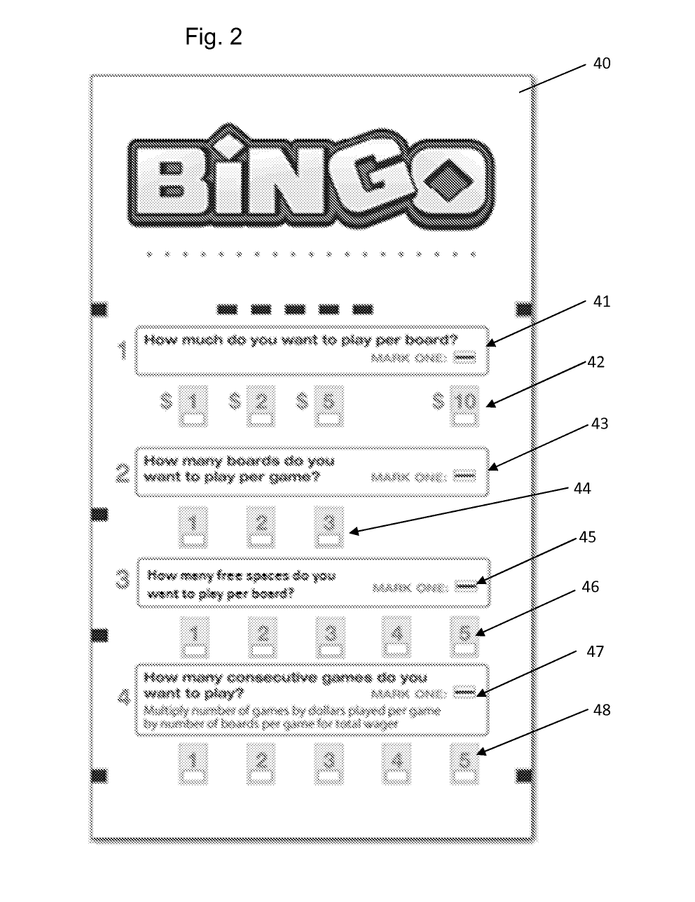

As shown in FIGS. 1 through 8, embodiments of the present invention provide for systems, methods and various apparatus for managing and conducting games of chance involving player-influenced odds of winning. As shown in the example system 10 of FIG. 1, a host 20 is provided in communication with various user devices via network 50. One user device 22 is shown as directly operable by a player 24, and this device can be a computing device such as a personal computer, laptop, tablet, and other similar computing devices, including other mobile communications devices such as smartphones, cellular telephone devices and wearable communications devices, for example. Such devices 22 include one or more processors, memory, programming, communications hardware and/or software, input/output mechanisms and a display suitably directed for the user 24 of this type of device. Another user device 26 is shown as directly operable by a player 28, and this user device 26 can be a computing device such as a self-service terminal, wherein the terminal 26 includes one or more processors, memory, programming, communications hardware and/or software, input/output mechanisms and a display suitably directed for the self-service terminal and permitting the receipt of input and display of output to a self-service terminal user 28.

Another user device 30 is shown in the form of a retail terminal, and this device 30 is operable by a retail clerk 32, for example, who may be interacting with a customer user 34 in a retail environment. The terminal 30 includes one or more processors, memory, programming, communications hardware and/or software, input/output mechanisms and a display suitably directed for the clerk 32 to facilitate the desired transaction of the user 34. Still another form of user device (e.g., 36a, 36b, 36c, 36d) is shown in the form of a gaming terminal tied to a group, wherein each terminal is operable by an individual user (e.g., 38a, 38b, 38c, 38d). Each terminal (e.g., 36a, 36b, 36c, 36d) includes one or more processors, memory, programming, communications hardware and/or software, input/output mechanisms and a display suitably directed to facilitate the desired operation of the user (e.g., 38a, 38b, 38c, 38d). It will be appreciated that group users may be organized in a certain gaming establishment so as to simultaneously play games such as Bingo and Keno, wherein the players are playing and/or wagering on the same game (e.g., the same randomly drawn or determined game indicia). It will further be appreciated that the number of terminals and users of those terminals can be more or less than the number illustrated in FIG. 1. The terminals (e.g., 36a, 36b, 36c, 36d) can be connected to the host 20 via network 50, either directly or via a display unit 40. The display unit 40 is in communication with the host 20 and is adapted to reveal game outcomes such as drawn/determined game indicia to the players (e.g., 38a, 38b, 38c, 38d). The display unit 40 can include one or more processors, memory, programming, communications hardware and/or software and a display suitably directed to facilitate the receipt and display of desired gaming information. It will be appreciated that the users (e.g., 38a, 38b, 38c, 38d) may be grouped in an area with terminals such as shown in FIG. 1, or without terminals. For example, users may be positioned within view of display 40, but with cards, tickets, receipts or other physical media that represent each user's respective game board for playing in accordance with the game indicia revealed on the display 40. In this way, the users do not require individual computing devices such as 36a, 36b, 36c and 36d, since the user has already established his or her wager as represented on the physical media, and the display 40 operates to facilitate play of the game represented by the physical media.

As further shown in FIG. 1, host 20 is provided with various components to facilitate management and operation of games of chance involving player-influenced odds of winning. For example, server 52 is provided, along with a game engine 54, random outcome generator 56, prize module 58, ticket generator 60 and database 62. Server 52 acts, at least in part, to receive communications from any of devices (e.g., 22, 26, 30, 36a-d) via network 50 and transmit communications from the host 20 to any of the same devices, including to display 40. The communications received by the server can comprise wager selections, such as player indicia and free space information as selected on a user device or a betslip, for example. The communications issued by the server can include receipts, tickets, cards, information to be provided on receipts, tickets and cards, game play information such as drawn or selected game indicia, promotional information, statistical information, game rules and other information.

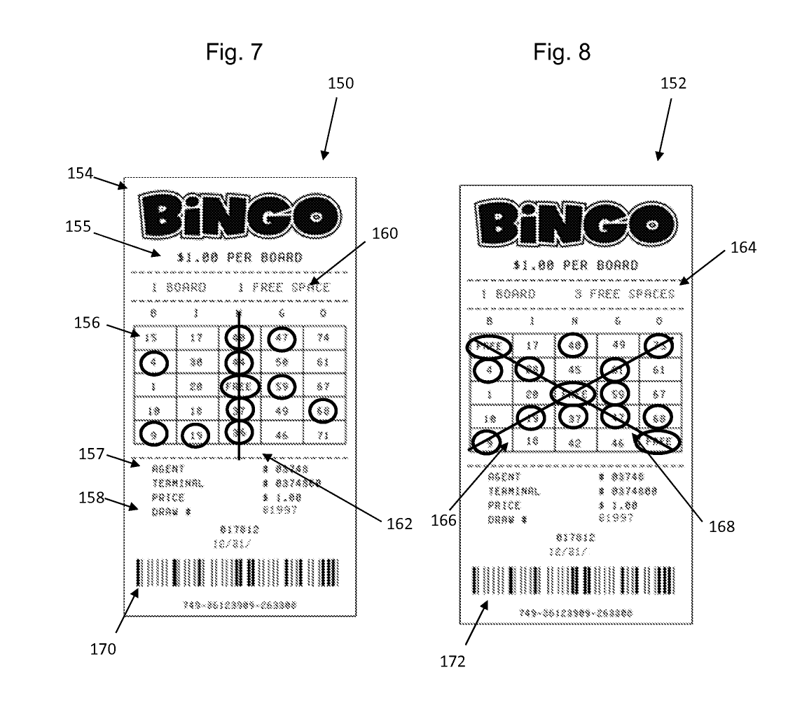

Game engine 54 acts, at least in part, to store, manage and conduct individual games in accordance with aspects of the present invention. For example, game engine 54 can store different wagering games for different game providers (such as, for example, government lotteries and casinos). Exemplary wagering games include Bingo and Keno. For a new game, the game engine 54 can establish rules of play, such as the number of game indicia available to be selected, the number of game indicia available to be drawn, the number of free spaces available to be selected, the cost of a wager and individual selections, the availability of repetitive play, the availability of selecting multiple boards per game, the prize structure(s) for each game, the display mechanisms, the validation format and the delivery format for wager confirmations, for example. The game engine 54 can provide instructions for each user device (e.g., 22, 26, 30, 36a-d, etc.) to use in displaying appropriate graphics to the user device displays, thereby permitting potential players to learn about the game and make wagering selections. The game engine 54 can access prizes and prize structures through a prize module 58, and/or a database 62, for example. Once the game is established, the game engine 54 can process wager requests from the user devices, process any payment of funds or utilization of loyalty points, and issue appropriate receipts, tickets, cards or other such information to confirm the wager made. In embodiments of the present invention, the host 20 includes a ticket generator module 60 that receives the processed wager request, and issues ticket details to be printed or displayed by a user device, for example. For example, the tickets and/or receipts 150, 152 in FIGS. 7 and 8, respectively, are populated with information that can be derived from ticket generator module 60 in embodiments of the present invention. Such information can include, for example, the name of the game 154, the cost per board 155, the game matrix with player indicia 156, point-of-purchase details 157, and the specific game details 158. It will be appreciated that the host 20 can include a separate payment processor component (not shown) and a loyalty component (not shown) for processing currency and loyalty transactions in connection with the embodiments of the present invention. Such components can be in communication with external resources via network 50, such as financial services company service providers who facilitate credit transaction processing, and other similar resources.

The game engine 54 can further process information for conducting of specific games, such as by receiving outcomes from a random outcome generator component 56 in order to provide the game indicia for a particular game. For example, once all wagers have been confirmed for a particular Bingo game, the players need to see the randomly drawn or determined game indicia in order to play the game and determine if they are winners. As each game indicia is determined by the game engine 54 (such as by employing random outcome generator component 56), the game indicia can be presented to the displays associated with the user devices, including display 40 and other displays intended for individual use. When the game is over, such as when one player has a matching pattern, the game engine 54 can consult the prize module to determine the appropriate prize for the winning individual.

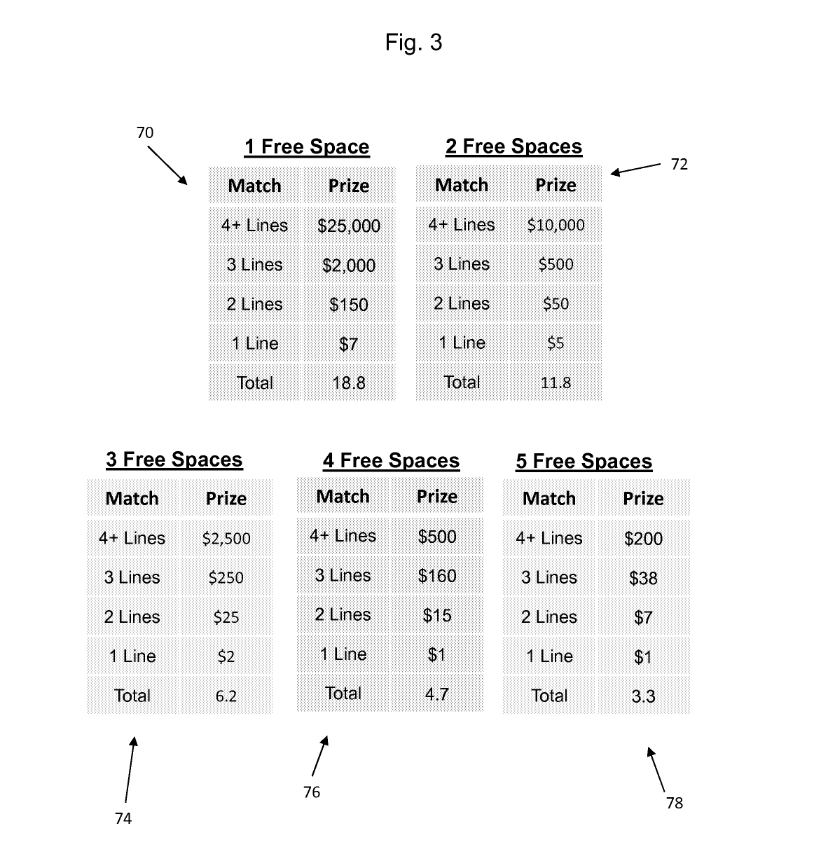

It will be appreciated that prizes according to the present invention may vary widely based upon the wagers made. For example, in embodiments of the present invention, multiple prize structures are provided depending upon the number of free spaces selected by the player when placing a wager. If, for example, the player can select up to five free spaces for a board in a particular game, then there would be five separate prize structures associated with that game. FIG. 3 illustrates such an example, as prize structure 70 is provided for one free space, prize structure 72 is provided for two free spaces, prize structure 74 is provided for three free spaces, prize structure 76 is provided for four free spaces and prize structure 78 is provided for five free spaces. It will be appreciated that other games can be conducted with a prize structure for zero free spaces, or for more than five free spaces. It will further be appreciated that the player's odds of winning may increase, but the prize payout may decrease, for each additional free space selected. Since having more free spaces increases the odds that a player will make a match sooner, and thereby increases the player's odds of winning, the payout for such increased odds is therefore lower. In this way, a player's selections for a particular wager influence the player's odds of winning, and therefore give the player a feeling of having more control over a given wager. Such a feeling of control can induce more players to play the game, and thus increases the attractiveness of games that can be offered, managed and conducted in accordance with embodiments of the present invention.

FIG. 3 illustrates an exemplary player betslip 40 for use in connection with embodiments of the present invention. It will be appreciated that the betslip 40 may be on physical media that can be presented by a user (e.g., 34 in FIG. 1) to a retail clerk (e.g., 32 in FIG. 1) for processing through a retailer terminal (e.g., 30 in FIG. 1), or may be processed through a self-service terminal (e.g., 26 in FIG. 1). It will further be appreciated that the betslip 40 can be represented electronically such as on a display of a user device (e.g., 36a-d, 22, 26, 30). The betslip 40 represents options and user selections for playing a game and/or placing a wager to play a game in accordance with aspects of the present invention.

As shown in FIG. 3, the betslip 40 can query the user for different selections of game options. As at 41, the betslip queries the user for the amount of the wager the user wishes to make per board, with options of $1, $2, $5, and $10 provided as shown at 42. As at 43, the betslip queries the user for the number of boards the user wishes to play per game, and provides the options of one, two or three as at 44. As at 45, the betslip queries the user for the number of free spaces the user wishes to have per board, and provides the options of one, two, three, four or five free spaces as at 46. As at 47, the betslip queries the user for the number of consecutive games the user wishes to play, and provides selection options of one, two, three, four or five as at 48. It will be appreciated that other selection options can be provide, as well as modifications of the above options. For instance, instead of selecting the number of free spaces per board, the betslip 40 can query the user for the number of free spaces to play on particular boards, such as one free space on board number one, two free spaces on board number two, and so forth. As a further example, the betslip 40 can query the user for the location of any selected free spaces, instead of automatically generating free spaces in the middle or corners of the grid. Additionally, the user may be queried to make a binary selection as to whether to include a free space in the exact middle of the grid, or not to include a free space in the exact middle of a grid. In various embodiments, if the player elects not to include a free space in the middle of the grid, the free space may be considered a “floating” free space that may be generated and positioned anywhere besides the exact middle of the grid. Further, the betslip may query the user for specific player indicia that the player wishes to play, which would require the user to designate the specific indicia in the “B” column, the specific indicia in the “I” column, and so forth. Without such a requirement, the present invention can operate such that the player indicia are randomly determined and presented to the user. It will be appreciated that player selections can affect the odds and amounts of potential winnings. For example, selecting multiple free spaces may increase the odds of winning but decrease the potential payout amount. Further, selecting a particular space (e.g., the middle space, a corner space, a non-middle space) as the location for a free space can increase or decrease the chances of winning depending upon the winning patterns applicable to a given game.

It will be appreciated that players can play games associated with the present invention alone (such as against a phantom player or computer) as well as against other players. It will further be appreciated that aspects of the present invention can operate such that the game is played in draw-based fashion or in instant-result fashion. For instant operations, the present invention can operate so as to provide a ticket (physical or virtual) that includes player indicia (e.g., selected or randomly determined) and one or more free spaces, along with a set of game indicia that are randomly determined, wherein the game indicia are optionally covered by a scratch-off material or simulated electronic covering. The game indicia on the ticket can be a subset of all available game indicia, such that the player can uncover and/or view all game indicia on the ticket in order to try to match the player indicia on the ticket in a pattern for a win. It will be appreciated that the player may not win each time, since the game indicia may be a finite number of indicia whereby the player does not mark enough of the player indicia to cover a winning pattern and thereby earn an award. For draw-based operations, the present invention can operate with a deadline for making wagers, after which the game engine can operate to determine randomly selected game indicia for presenting to players, at which time the players can cover any “called” indicia until one or more players win the game according to the specific rules of play. It will be appreciated that the game can be operated with a finite number of “called” numbers (i.e., game indicia), such that there may be one or more winners, or there may be no winners of any given game.

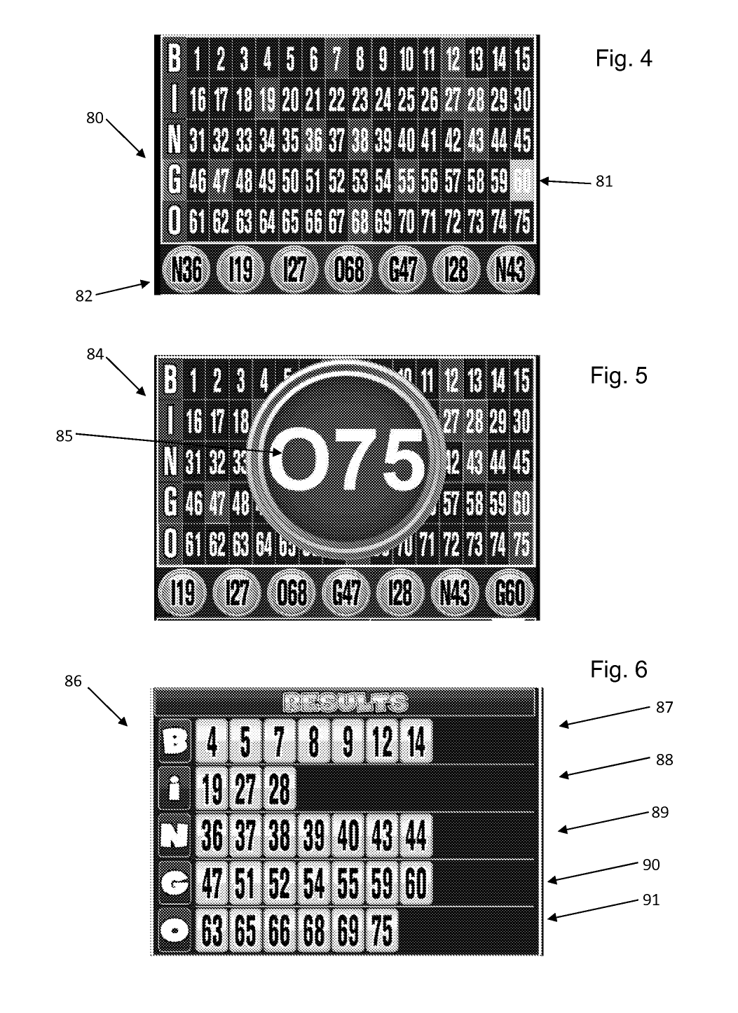

Draws can be conducted on devoted displays (such as display 40, device 22, device 26, etc.). Further draws can be conducted at regular time intervals, including multiple times per day if desired. FIGS. 4 through 6 illustrate sample displays showing drawn game indicia. For example, in the display 80 of FIG. 4, a recently drawn number can be highlighted as shown at 81. Further, previously drawn numbers can be shown as at 82. In the display 84 of FIG. 5, the currently drawn number can be presented as an overlay in larger type as illustrated at 85. As illustrated in the display 86 of FIG. 6, the drawn game indicia can be illustrated in linear form next to a corresponding letter icon, as shown at 87 for “B”, 88 for “I”, 89 for “N”, 90 for “G” and 91 for “O”. It will be appreciated that “drawn” numbers can also include numbers that are not literally drawn from a container, such as ping pong balls from a revolvable bin, for example, but rather are selected or otherwise determined by a computer system in accordance with aspects of the present invention.

As shown in FIGS. 7 and 8, players can receive physical or virtual tickets, cards or receipts as indicated by 150 and 152, respectively, representing each player's wager and player indicia. As game indicia are determined and players are informed, players can mark their tickets, cards and/or receipts accordingly in order to play the game and determine if the player is a winner. For instance, in the example of FIG. 7, the player has selected one free space as at 160, and the player has made a vertical match through the “N” column including the free space, as indicated at 162. In the example of FIG. 8, the player has selected three free space as at 164, and the player has made two diagonal matches as indicated at 166 and 168. Barcodes can be provided as at 170 and 172 in order to facilitate validation of winning entries, upon a player going to a terminal to confirm a win and collect winnings, for example.

Winnings are determined based on prize structures. Thus, for example, for a one-line win in connection with a one-free-space wager for $1 as illustrated in FIG. 7, the player would collect $7 as shown in FIG. 3 in table 70. As another example, for a two-line win in connection with a three-free-space wager for $1 as illustrated in FIG. 8, the player would collect $25 as shown in FIG. 3 in table 74. It will be appreciated that various forms of patterns can be employed for informing the player as to what matches will result in a win. For example, linear patterns including horizontal, vertical and diagonal patterns can be employed. Further, non-linear patterns such as diamond, barbell, flagpost and other non-linear patterns can be employed.

It will thus be appreciated that embodiments of the present invention involve a system, apparatus and method including one or more betslips, a host and one or more processors for executing programming that awards a prize associated with winning game cards, receipts or tickets when randomly drawn game indicia match a designated pattern of player indicia. It will be appreciated that the terms card, receipt and ticket can be used interchangeably herein to describe a representation of a player's desired game play and/or wager. The betslip is provided to receive a selection for a number of free spaces to apply to a game of chance. The betslip can be provided in a physical media, such as paper, and can also be provided virtually, such as an electronically represented betslip on a display of a user device. As described above, the host can generate randomly determined and/or pre-determined player indicia and game indicia, and can facilitate the issuance of at least one player card with the player indicia, the requested number of free spaces and at least one pattern including at least a portion of the player indicia thereon.

In facilitating card, ticket or receipt issuance, the host can operate to process requested game play and/or wager information as received from users, obtain randomly generated player and game indicia, associate the randomly generated player indicia with the player request, store the associated indicia and request information in a database, optionally generate a validation code (such as through game engine 154) and associate the validation code with the associated indicia and request information, deliver the code, player indicia, relevant request information to a device, and instruct the device to display, print or otherwise reveal the delivered information to a requesting player. In this way, while the host may not print tickets, it delivers suitable information for a player to recognize that his or her wager has been appropriately processed (via a printed or displayed ticket, receipt or card, for example), while also storing necessary information to be able to confirm that the player is a winner as appropriate and in accordance with game play. It will be appreciated that, in alternative embodiments, the host may print a variety of pre-packaged tickets with zero, one or more free spaces, player indicia and a validation code already thereupon, and may distribute such tickets to retailers for physical sale in connection with a drawing. In this way, the host provides another form of facilitating card, ticket or receipt issuance.

In embodiments of the present invention, the host stores a plurality of prize structures, including a first prize structure associated with a single free space, and one or more additional prize structures associated with a plurality of free spaces. Separately, it is within the scope of operation to provide an additional prize structure associated with zero free spaces. The prize structures can include prizes to be awarded in the event of different types of pattern matches, based at least upon the number of free spaces selected and the dollar amount wagered.

Embodiments of the present invention further involve a system, apparatus and method for providing a game of chance, including a host for storing a first prize structure for game tickets including at least one game board having one free space per board, storing a second prize structure for game tickets including at least one game board having zero or a plurality of free spaces per board, and generating randomly determined game indicia, along with at least one processor for executing programming to award a prize associated with one or more of the boards based on the randomly determined game indicia. The game tickets can be on physical media or can be virtual. The host can further receive a request for a game ticket including at least one game board, wherein the request includes a request for zero, one or a plurality of free spaces, and can thereafter facilitate the issuance of the requested game ticket. In one embodiment of the present invention, the game ticket includes at least a subset of the randomly determined game indicia. Such an embodiment may arise, for example, where the game is played as an instant ticket, and the subset of the randomly determined game indicia are provided to give the player the impression of a draw-based game, with a limited number of randomly determined game indicia.

The game of the present invention can operate with traditional print tickets, tickets purchased and/or played over the Internet, and tickets purchased as part of a subscription. The game can further operate as part of an electronic instant ticket, a video lottery terminal game, a “play for fun” game with no monetary value, a game that awards credits or prizes instead of money, a mobile application game, a Bingo game, a slot game, a Keno game, a game that is revealed on a monitor, a game that is associated with a public or private drawing, and other games.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present invention to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, satellite, EDGE and EVDO, for example. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present invention, as will be understood to one of ordinary skill in the art.

The present disclosure describes numerous embodiments of the present invention, and these embodiments are presented for illustrative purposes only. These embodiments are described in sufficient detail to enable those skilled in the art to practice the invention, and it will be appreciated that other embodiments may be employed and that structural, logical, software, electrical and other changes may be made without departing from the scope or spirit of the present invention. Accordingly, those skilled in the art will recognize that the present invention may be practiced with various modifications and alterations. Although particular features of the present invention can be described with reference to one or more particular embodiments or figures that form a part of the present disclosure, and in which are shown, by way of illustration, specific embodiments of the invention, it will be appreciated that such features are not limited to usage in the one or more particular embodiments or figures with reference to which they are described. The present disclosure is thus neither a literal description of all embodiments of the invention nor a listing of features of the invention that must be present in all embodiments.

1. A system for providing a game of chance, comprising:
at least one player betslip for receiving a selection for a number of free spaces to apply to a game of chance;
a host for generating randomly determined player indicia and game indicia, and for facilitating the issuance of at least one player card with the player indicia, the requested number of free spaces and at least one pattern including at least a portion of the player indicia thereon; and
at least one processor for executing programming to award a prize associated with the player card upon the game indicia matching the portion of the player indicia comprising the at least one pattern on the player card.

2. The system of claim 1, wherein the betslip is provided on a display for displaying a player selection interface.

3. The system of claim 1, wherein the host stores a plurality of prize structures, including a first prize structure associated with a single free space, and a second prize structure associated with zero or a plurality of free spaces.

4. The system of claim 1 wherein the player card is displayed on a player display.

5. The system of claim 1, further including a game display for displaying the randomly determined game indicia.

6. A system for providing a game of chance, comprising:
a host for storing a first prize structure for game tickets including at least one game board having one free space per board, storing a second prize structure for game tickets including at least one game board having zero or a plurality of free spaces per board, and generating randomly determined game indicia; and
at least one processor for executing programming to award a prize associated with one or more of the boards based on the randomly determined game indicia.

7. The system of claim 6, wherein the game tickets are virtual.

8. The system of claim 6, wherein the host is further provided for: receiving a request for a game ticket including at least one game board, wherein the request includes a request for zero, one or a plurality of free spaces; and for facilitating the issuance of the requested game ticket.

9. The system of claim 8, wherein the host is further provided for sending game ticket information to a terminal.

10. The system of claim 9, wherein the terminal is one of: a retailer terminal, a self-service terminal, a player mobile communications device.

11. The system of claim 8, wherein the game ticket includes at least a subset of the randomly determined game indicia.

12. The system of claim 6, wherein the host is further provided for transmitting the game indicia to a game display.

13. A method for operating a game of chance, comprising:
providing a first prize structure associated with a first game of chance involving a single free space;
providing a second prize structure associated with a second game of chance involving zero or a plurality of free spaces;
receiving a wager request in connection with the first game of chance, and facilitating the issuance of a first player ticket including player indicia within a first grid, at least one first grid pattern and a single free space identified within the first grid;
receiving a wager request in connection with the second game of chance, and facilitating the issuance of a second player ticket including player indicia within a second grid, at least one second grid pattern and zero or a plurality of free spaces identified within the second grid;
generating randomly determined game indicia; and
awarding a prize upon the game indicia resulting in a match with the player indicia corresponding to the at least one first grid pattern or the at least one second grid pattern.

14. The method of claim 13 including the steps of issuing the first player ticket to a first terminal, and issuing the second player ticket to a second terminal.

15. The method of claim 13, wherein the terminal is one of: a retailer terminal, a self-service terminal, a player mobile communications device.

16. The method of claim 13, wherein the first and second player tickets are virtual.

17. A method for operating a game, comprising:
receiving, from a player, a selection of the number of free spaces to be employed on a game board for a first game of chance;
generating a game board incorporating the number of free spaces selected and a plurality of player indicia;
conducting a drawing where game indicia are randomly determined for comparison with the player indicia on the game board; and
determining whether the player is a winner.

18. The method of claim 17, including the further step of providing a first prize structure associated with the first game of chance involving a single free space, and providing a second prize structure associated with a second game of chance involving zero or a plurality of free spaces.

19. The method of claim 17, including the step of issuing the player's game board to a first terminal.

20. The method of claim 19, wherein the terminal is one of: a retailer terminal, a self-service terminal, a player mobile communications device.

21. The method of claim 19, wherein the game board is randomly generated.

22. The method of claim 19, wherein receiving a selection of the number of free spaces includes receiving a selection associated with one or more free space locations.
